(19) United States
(12) Patent Application Publication
(10) Pub. No.: US 2025/0000139 A1
(43) Pub. Date: Jan. 2, 2025

(54) AEROSOL-GENERATING ARTICLE WITH PHOTOLUMINESCENT TAGGANT

(71) Applicant: Philip Morris Products S.A., Neuchatel (CH)

(72) Inventors: Michel BESSANT, Neuchâtel (CH); Patrick Philippe MONNEY, Mex (CH)

(73) Assignee: Philip Morris Products S.A., Neuchatel (CH)

(21) Appl. No.: 18/701,950

(22) PCT Filed: Oct. 25, 2022
(86) PCT No.: PCT/EP2022/079729

§ 371 Date: Apr. 17, 2024

(30) Foreign Application Priority Data
Oct. 25, 2021 (WO) PCT/CN2021/126124

(51) Int. Cl. A24F 40/20; A24D 1/02; A24F 40/42; A24F 40/51; H05B 45/14

(52) U.S. Cl. CPC A24F 40/20; A24D 1/025; A24F 40/42; A24F 40/51; H05B 45/14

(57) ABSTRACT

An aerosol-generating article is provided, including: an aerosol-forming substrate; and a taggant including a photoluminescent material having an emission half-life of between 50 microseconds and 1000 microseconds after photoexcitation of the photoluminescent material. An aerosol-generating system including the aerosol-generating article and an aerosol-generating device is also provided. An aerosol-generating device is also provided.

The present disclosure relates to an aerosol-generating article comprising an aerosol-forming substrate. In particular, the present disclosure relates to an aerosol-generating article comprising an aerosol-forming substrate, the aerosol-generating article also including a taggant comprising a photoluminescent material. The present disclosure also relates to an aerosol-generating system comprising the aerosol-generating article and an aerosol-generating device. The present disclosure also relates to an aerosol-generating device comprising a source of radiation and a photodetector.

Aerosol generating devices which heat an aerosol-forming substrate to produce an aerosol without burning the aerosol-forming substrate are known in the art. The aerosol-forming substrate is typically provided within an aerosol-generating article, together with other components such as one or more filter segments. The aerosol-generating article may have a rod shape for insertion of the aerosol-generating article into a cavity of the aerosol-generating device. A heating element is typically arranged to heat the aerosol-forming substrate once the aerosol-generating article is inserted into the cavity of the aerosol-generating device. The heating element may comprise an internal heating element that extends into the cavity and is received in the aerosol-generating article. The heating element may comprise an external heating element arranged to extend around the outside of the aerosol-generating. The combination of the aerosol-generating device and the aerosol-generating article may be referred to as an aerosol-generating system.

Aerosol-generating articles developed for use in an aerosol-generating system are typically specially designed, because the flavours are generated and released by a controlled heating of the aerosol-forming substrate, without the combustion that takes place in lit-end cigarettes and other smoking articles. Therefore, the structure of the aerosol-generating article may be different from the structure of a lit-end smoking article. Using a lit-end smoking article with an aerosol-generating device may result in a poor smoking experience for the user, and may also damage the aerosol-generating device because, for example, the smoking article is not compatible with the aerosol-generating device.

Nonetheless, it is conceivable that a user may, inadvertently or otherwise, attempt to use an aerosol-generating article with an aerosol-generating device where the device is not designed to be used with the article. For example, a user may attempt to use a lit-end cigarette, or a counterfeit aerosol-generating article in an aerosol-generating device. This may result in poor aerosol-generation and reduced user experience which may reflect badly on the aerosol-generating device. In addition, the use of aerosol-generating articles other than those intended may damage the aerosol-generating device.

In addition, there may be a number of different aerosol-generating articles which are each configured for use with the aerosol-generating device, but which each provide a different smoking experience for the user. It may be desirable for one of more heating elements of the aerosol-generating device to reach different temperatures at different times (that is, have a different heating profile) depending on the variety or flavour of aerosol-generating article used with the aerosol-generating device. In such examples, it would be desirable for the aerosol-generating device to alter the temperature settings automatically without a user needing to enter any details manually.

It would be desirable to provide an aerosol-generating article, an aerosol-generating device and an aerosol-generating system that facilitates detection of the presence of particular aerosol-generating articles. Where the aerosol-generating device does not recognise a particular aerosol-generating article, it would be desirable to prevent activation of a heating element to prevent a poor user experience. In addition, where the aerosol-generating device detects a particular recognised aerosol-generating article, it would be desirable for the aerosol-generating to operate a heating element according to a particular heating profile configured specifically for use with that variety of aerosol-generating article.

According to an example of the present disclosure there is provided an aerosol-generating article. The aerosol-generating article may comprise an aerosol-forming substrate. The aerosol-generating article may comprise a taggant. The taggant may comprise a photoluminescent material. The photoluminescent material may have an emission half-life of between about 50 microseconds and about 1000 microseconds after photoexcitation of the photoluminescent material.

According to another example of the present disclosure, there is provided an aerosol-generating article comprising an aerosol-forming substrate and a taggant. The taggant comprises a photoluminescent material having an emission half-life of between about 50 microseconds and about 1000 microseconds after photoexcitation of the photoluminescent material.

As used herein, the term “aerosol-generating article” refers to an article comprising an aerosol-forming substrate that, when heated in the aerosol-generating device, releases volatile compounds that can form an aerosol. An aerosol-generating article is separate from and configured for combination with the aerosol-generating device for heating the aerosol-generating article.

The term “taggant” is used herein to refer to a photoluminescent material provided on at least a portion of the aerosol-generating article, the presence of which may be detected by a suitable detector to enable identification of the aerosol-generating article.

The term “emission half-life” is used herein to refer to the time taken for an intensity of radiation emission by the photoluminescent material to decay by half after the photoluminescent material has been irradiated by a source of radiation and after the source of radiation has been removed or switched off.

Advantageously, providing a photoluminescent material having a known emission half-life allows the taggant to be used to identify the aerosol-generating article by an aerosol-generating device. Advantageously, an aerosol-generating device may be configured to operate in different ways depending on the particular aerosol-generating article recognised by the aerosol-generating device.

Advantageously, a taggant comprising a photoluminescent material may be more difficult to copy during the production of counterfeit aerosol-generating articles when compared to known systems comprising identifiable ink patterns. For example, it may be impossible to produce a counterfeit article without determining at least one of the particular photoluminescent material, one or more wavelengths of radiation at which the photoluminescent material may be excited, and one or more wavelengths at which the photoluminescent material may emit radiation.

Advantageously, providing a photoluminescent material having an emission half-life of between about 50 microseconds and about 1000 microseconds may facilitate fast identification of the aerosol-generating article by an aerosol-generating device.

Advantageously, an emission half-life of between about 50 microseconds and about 1000 microseconds may be sufficiently long to facilitate consistent and accurate determination of the half-life by an aerosol-generating device. In embodiments in which the photoluminescent material exhibits photoluminescence at one or more infrared wavelengths, an emission half-life of between about 50 microseconds and about 1000 microseconds may be sufficiently long to distinguish the taggant from other material used in the aerosol-generating article that may emit infrared radiation for several milliseconds after exposure to an infrared source.

The photoluminescent material may have an emission half-life of at least about 60 microseconds. The photoluminescent material may have an emission half-life of at least about 70 microseconds. The photoluminescent material may have an emission half-life of at least about 80 microseconds. The photoluminescent material may have an emission half-life of at least about 90 microseconds. The photoluminescent material may have an emission half-life of at least about 100 microseconds. The photoluminescent material may have an emission half-life of at least about 110 microseconds. The photoluminescent material may have an emission half-life of at least about 120 microseconds. The photoluminescent material may have an emission half-life of at least about 130 microseconds. The photoluminescent material may have an emission half-life of at least about 140 microseconds. The photoluminescent material may have an emission half-life of at least about 150 microseconds. The photoluminescent material may have an emission half-life of at least about 160 microseconds. The photoluminescent material may have an emission half-life of at least about 170 microseconds. The photoluminescent material may have an emission half-life of at least about 180 microseconds. The photoluminescent material may have an emission half-life of at least about 190 microseconds. The photoluminescent material may have an emission half-life of at least about 200 microseconds.

The photoluminescent material may have an emission half-life of less than about 900 microseconds. The photoluminescent material may have an emission half-life of less than about 800 microseconds. The photoluminescent material may have an emission half-life of less than about 700 microseconds. The photoluminescent material may have an emission half-life of less than about 600 microseconds. The photoluminescent material may have an emission half-life of less than about 500 microseconds. The photoluminescent material may have an emission half-life of less than about 400 microseconds. The photoluminescent material may have an emission half-life of less than about 300 microseconds. The photoluminescent material may have an emission half-life of less than about 280 microseconds. The photoluminescent material may have an emission half-life of less than about 260 microseconds. The photoluminescent material may have an emission half-life of less than about 250 microseconds. The photoluminescent material may have an emission half-life of less than about 240 microseconds. The photoluminescent material may have an emission half-life of less than about 230 microseconds. The photoluminescent material may have an emission half-life of less than about 220 microseconds. The photoluminescent material may have an emission half-life of less than about 210 microseconds. The photoluminescent material may have an emission half-life of less than about 200 microseconds.

The photoluminescent material may have an emission half-life of between about 100 microseconds and about 800 microseconds. The photoluminescent material may have an emission half-life of between about 100 microseconds and about 500 microseconds. The photoluminescent material may have an emission half-life of between about 100 microseconds and about 300 microseconds. The photoluminescent material may have an emission half-life of between about 120 microseconds and about 250 microseconds. The photoluminescent material may have an emission half-life of between about 160 microseconds and about 200 microseconds.

Preferably, the photoluminescent material is excitable by infrared radiation.

Advantageously, infrared radiation may be more easily transmitted through materials used to form the aerosol-generating article compared to other wavelengths of radiation. For example, in embodiments in which the taggant is provided on an inner surface of a wrapper, infrared radiation may be transmitted through the wrapper to excite the photoluminescent material.

Advantageously, infrared radiation is relatively safe for user of the aerosol-generating article.

The photoluminescent material may be excitable by infrared radiation within a wavelength range of between about 700 nanometres and about 1050 nanometres.

Preferably, the photoluminescent material exhibits photoluminescence in the infrared range. In other words, preferably the photoluminescent material emits infrared radiation. The photoluminescent material may exhibit photoluminescence across a range of wavelengths. Preferably, the photoluminescent material has a peak emission at a wavelength in the infrared range. The photoluminescent material may have a single peak emission. Preferably, the single peak emission occurs at a wavelength in the infrared range.

The photoluminescent material may exhibit photoluminescence within a wavelength range of between about 700 nanometres and about 1100 nanometres. The photoluminescent material may have a peak emission at a wavelength of between about 700 nanometres and about 1100 nanometres.

The photoluminescent material may exhibit photoluminescence within a wavelength range of between about 950 nanometres and about 1050 nanometres. The photoluminescent material may have a peak emission at a wavelength of between about 950 nanometres and about 1050 nanometres.

Preferably, the photoluminescent material comprises a phosphorescent material. The skilled person can select suitable materials based on an emission half-life, excitation wavelength and emission wavelength of the materials.

The taggant may be provided on a surface of the aerosol-generating article at any suitable concentration. The taggant may be provided at a density of at least about 200 milligrams per square metre, preferably at least about 300 milligrams per square metre, preferably at least about 400 milligrams per square metre, preferably at least about 500 milligrams per square metre, preferably at least about 600 grams per square metre. The taggant may be provided at a density of less than about 1100 milligrams per square metre, preferably less than about 1000 milligrams per square metre, preferably less than about 900 milligrams per square metre, preferably less than about 800 milligrams per square metre, preferably less than about 700 milligrams per square metre. For example, the taggant may be provided at a density of between about 200 and about 1100 milligrams per square metre, preferably between about 300 and about 1000 milligrams per square metre, preferably between about 400 and about 900 milligrams per square metre, preferably between about 500 and about 800 milligrams per square metre, preferably between about 600 and about 700 milligrams per square metre. The taggant may be provided at a density of about 620 milligrams per square metre.

The taggant may be provided on an outer surface of the aerosol-generating article. Advantageously, providing the taggant on an outer surface of the aerosol-generating article may facilitate direct exposure of the taggant to a radiation source. Advantageously, providing the taggant on an outer surface of the aerosol-generating article may facilitate direct exposure of the taggant to a photodetector.

The taggant may be provided on an inner surface of the aerosol-generating article. Advantageously, providing the taggant on an inner surface of the aerosol-generating article may reduce of prevent contamination of the taggant or damage to the taggant. The term “inner surface” is used herein to refer to a surface of a component of the aerosol-generating article that does not form part of an exterior or outer surface of the aerosol-generating article.

The aerosol-generating article may comprise a wrapper. The wrapper be a paper wrapper. The wrapper may be formed form a polymeric film. The wrapper may be formed from a laminate material. The wrapper may be a wrapper circumscribing the aerosol-forming substrate. The wrapper may be a tipping wrapper.

The taggant may be provided on a surface of the wrapper. The taggant may be provided on an outer surface of the wrapper. The taggant may be provided on an inner surface of the wrapper.

The wrapper may be a thin wrapper. Advantageously, a thin wrapper may facilitate transmission of radiation through the wrapper when the taggant is provided on an inner surface of the wrapper. The wrapper may have a thickness of less than about 50 micrometres. The wrapper may have a thickness of less than about 40 micrometres. The wrapper may have a thickness of less than about 30 micrometres. The wrapper may have a thickness of less than about 20 micrometres. The wrapper may have a thickness of less than about 10 micrometres.

The taggant may be provided as a continuous band circumscribing a portion of the aerosol-generating article. Advantageously, providing the taggant as a continuous band may eliminate the need for a user to insert the aerosol-generating article into an aerosol-generating device with any particular rotational orientation.

In embodiments in which the taggant is provided on an outer surface of the aerosol-generating article, the taggant may be provided as a continuous band circumscribing a portion of the outer surface.

The aerosol-forming substrate may be provided as a segment of aerosol-forming substrate. The aerosol-generating article may further comprise at least one further segment positioned downstream of the segment of aerosol-forming substrate.

As used herein, the terms “upstream” and “downstream” refer to the direction of airflow through the aerosol-generating article during use of the aerosol-generating article. During use, air flows from upstream to downstream.

In embodiments in which the aerosol-generating article comprises a wrapper, the wrapper may circumscribe the at least one further segment. In embodiments in which the at least one further segment comprises a plurality of further segments, the wrapper may circumscribe at least one of the further segments. The wrapper may join the at least one further segment to the segment of aerosol-forming substrate. For example, the wrapper may be a tipping wrapper or a combining wrapper.

The at least one further segment may comprise at least one hollow tube positioned downstream of the segment of aerosol-forming substrate. The hollow tube may be an acetate tube. The hollow tube may be a cardboard tube.

The at least one further segment may comprise at least one filter segment positioned downstream of the at least one hollow tube. Preferably, the at least one filter segment comprises cellulose acetate fibres. The at least one filter segment may form a mouthpiece. The at least one filter segment may be positioned at a “mouth end” or “downstream end” of the aerosol-generating article.

The segment of aerosol-forming substrate may be positioned at an upstream end of the aerosol-generating article.

The aerosol-generating article may comprise an upstream segment positioned upstream of the segment of aerosol-forming substrate. The upstream segment may be positioned at an upstream end of the aerosol-generating article. The upstream segment may comprise a hollow tube. The hollow tube may be an acetate tube. The hollow tube may be a cardboard tube.

Preferably, the aerosol-forming substrate comprises tobacco.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5 percent on a dry weight basis. Homogenised tobacco material may alternatively have an aerosol former content of between 5 percent and 30 percent by weight on a dry weight basis. Sheets of homogenised tobacco material may be formed by agglomerating particulate tobacco obtained by grinding or otherwise comminuting one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

In a particularly preferred embodiment, the aerosol-forming substrate comprises a gathered crimped sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Although reference is made to solid aerosol-forming substrates above, it will be clear to one of ordinary skill in the art that other forms of aerosol-forming substrate may be used with other examples. The liquid aerosol-forming substrate may be absorbed into a porous carrier material. The porous carrier material may be made from any suitable absorbent plug or body, for example, a foamed metal or plastics material, polypropylene, terylene, nylon fibres or ceramic. The liquid aerosol-forming substrate may be retained in the porous carrier material prior to use or, alternatively, the liquid aerosol-forming substrate material may be released into the porous carrier material during, or immediately prior to use. For example, the liquid aerosol-forming substrate may be provided in a capsule. The shell of the capsule preferably melts upon heating and releases the liquid aerosol-forming substrate into the porous carrier material. The capsule may optionally contain a solid in combination with the liquid.

Alternatively, the carrier may be a non-woven fabric or fibre bundle into which tobacco components have been incorporated. The non-woven fabric or fibre bundle may comprise, for example, carbon fibres, natural cellulose fibres, or cellulose derivative fibres.

In embodiments in which the aerosol-generating article comprises at least one further segment positioned downstream of the segment of aerosol-forming substrate, the taggant may be provided on the at least one further segment, or the taggant may be provided on a portion of a wrapper overlying the at least one further segment.

The upstream end of the taggant may be at least about 0.5 millimetres from a downstream end of the segment of aerosol-forming substrate. The upstream end of the taggant may be at least about 1 millimetre from a downstream end of the segment of aerosol-forming substrate. The upstream end of the taggant may be at least about 1.5 millimetres from a downstream end of the segment of aerosol-forming substrate. The upstream end of the taggant may be at least about 2 millimetres from a downstream end of the segment of aerosol-forming substrate.

The upstream end of the taggant may be located no more than about 5 millimetres from the downstream end of the aerosol-forming substrate. The upstream end of the taggant may be located no more than about 4 millimetres from the downstream end of the aerosol-forming substrate. The upstream end of the taggant may be located no more than about 3 millimetres from the downstream end of the aerosol-forming substrate. The upstream end of the taggant may be located no more than about 2 millimetres from the downstream end of the aerosol-forming substrate.

The upstream end of the taggant may be located about 2 millimetres from the downstream end of the aerosol-forming substrate.

In embodiments in which the taggant is provided on a wrapper, the upstream end of the taggant may be aligned with an upstream end of the wrapper. This may advantageously simplify the manufacture of the aerosol-generating article.

The upstream end of the taggant may be at least about 10 millimetres from the upstream end of the aerosol-generating article. The upstream end of the taggant may be at least about 15 millimetres from the upstream end of the aerosol-generating article. The upstream end of the taggant may be at least about 19 millimetres from the upstream end of the aerosol-generating article. The upstream end of the taggant may be about 19 millimetres from the upstream end of the aerosol-generating article.

The upstream end of the taggant may be at least about 14 millimetres from the downstream end of the aerosol-generating article. The upstream end of the taggant may be at least about 20 millimetres from the downstream end of the aerosol-generating article. The upstream end of the taggant may be at least about 26 millimetres from the downstream end of the aerosol-generating article. The upstream end of the taggant may be about 26 millimetres from the downstream end of the aerosol-generating article.

The downstream end of the taggant may be at least about 10 millimetres from the downstream end of the aerosol-generating article. The downstream end of the taggant may be at least about 15 millimetres from the downstream end of the aerosol-generating article. The downstream end of the taggant may be at least about 19 millimetres from the downstream end of the aerosol-generating article. The downstream end of the taggant may be about 19.5 millimetres from the downstream end of the aerosol-generating article.

The downstream end of the taggant may be at least about 14 millimetres from the upstream end of the aerosol-generating article. The downstream end of the taggant may be at least about 20 millimetres from the upstream end of the aerosol-generating article. The downstream end of the taggant may be at least about 25 millimetres from the upstream end of the aerosol-generating article. The downstream end of the taggant may be about 25.5 millimetres from the upstream end of the aerosol-generating article.

The taggant may be printed on the wrapper. The taggant may be sprayed, or painted on the wrapper.

The aerosol-generating article may comprise at least one susceptor element in thermal contact with the segment of aerosol-forming substrate.

The at least one susceptor element may comprise a plurality of susceptor particles. Preferably, the plurality of susceptor particles are distributed within the aerosol-forming substrate.

The at least one susceptor element may comprise an internal susceptor element positioned within the segment of aerosol-forming substrate. The internal susceptor element may comprise a rod, a pin or a sheet of susceptor material positioned within the aerosol-forming substrate.

The at least one susceptor element may comprise an external susceptor element extending around an external surface of the segment of aerosol-forming substrate. The external susceptor element may comprise a sheet of susceptor material wrapped around at least a portion of the segment of aerosol-forming substrate.

Preferably, the aerosol-generating article is substantially cylindrical in shape. The aerosol-generating article may be substantially elongate. The segment of aerosol-forming substrate may be substantially cylindrical in shape. The segment of aerosol-forming substrate may be substantially elongate.

The aerosol-generating article may have a total length between approximately 30 millimetres and approximately 100 millimetres. The aerosol-generating article may have a total length of approximately 45 millimetres.

The aerosol-generating article may have an external diameter between approximately 5 millimetres and approximately 12 millimetres, preferably between approximately 6 millimetres and approximately 10 millimetres, preferably between approximately 7 millimetres and approximately 8 millimetres, preferably between approximately 7.0 millimetres and approximately 7.4 millimetres. The aerosol-generating article may have an external diameter of approximately 7.3 millimetres.

The segment of aerosol-forming substrate may have a length of between approximately 10 millimetres and approximately 18 millimetres. Further, the diameter of the segment of aerosol-forming substrate may be between approximately 5 millimetres and approximately 12 millimetres.

The at least one filter segment may have a length of between approximately 5 millimetres to approximately 12 millimetres. The at least one filter segment may have a length of approximately 7 millimetres.

According to another example of the present disclosure there is provided an aerosol-generating system comprising an aerosol-generating article in accordance with any of the examples or embodiments described herein, and an aerosol-generating device. The aerosol-generating device may comprise a cavity for receiving at least a portion of the aerosol-generating article. The aerosol-generating device may comprise a source of radiation arranged to irradiate the taggant when the aerosol-generating article is received within the cavity. The aerosol-generating device may comprise a photodetector arranged to detect radiation emitted by the photoluminescent material when the aerosol-generating article is received within the cavity.

According to another example of the present disclosure there is provided an aerosol-generating system comprising an aerosol-generating article in accordance with any of the examples or embodiments described herein, and an aerosol-generating device. The aerosol-generating device comprises a cavity for receiving at least a portion of the aerosol-generating article. The aerosol-generating device also comprises a source of radiation arranged to irradiate the taggant when the aerosol-generating article is received within the cavity. The aerosol-generating device also comprises a photodetector arranged to detect radiation emitted by the photoluminescent material when the aerosol-generating article is received within the cavity.

The source of radiation may comprise a light emitting diode. Preferably, the light emitting diode is configured to emit radiation having at least one wavelength at which the photoluminescent material may be excited. The light emitting diode may be configured to emit infrared radiation. The light emitting diode may be configured to emit infrared radiation within a wavelength range of between about 700 nanometres and about 1100 nanometres.

The photodetector may comprise a photodiode.

The aerosol-generating device may comprise a power supply.

The aerosol-generating device may comprise at least one heating element.

The aerosol-generating device may comprise a controller configured to supply power from the power supply to the light emitting diode for a first time period to irradiate the taggant with radiation from the light emitting diode when the aerosol-generating article is received within the cavity. The first time period may be between about 200 microseconds and about 1.5 milliseconds.

The controller may be configured to supply power from the power supply to the photodiode for a second time period after the first time period. The controller may be configured to prevent the supply of power from the power supply to the light emitting diode during the second time period. The controller may be configured to receive a signal from the photodiode during the second time period. The signal may be indicative of an intensity of photoluminescence by the taggant.

The second time period may be between about 200 microseconds and about 1.5 milliseconds.

The controller may be configured to determine an emission half-life of the photoluminescent material of the taggant based on the signal received from the photodiode during the second time period. The controller may be configured to control further operation of the aerosol-generating device based on the determined emission half-life.

The controller may be configured to compare the determined emission half-life with a look-up table of emission half-lives corresponding to taggants of aerosol-generating articles configured for use with the aerosol-generating device. The controller may be configured so that the controlling further operation of the aerosol-generating device based on the determined emission half-life comprises preventing a supply of power from the power supply to the at least one heating element unless the determined emission half-life corresponds to an aerosol-generating article configured for use with the aerosol-generating device. The controller may be configured to supply power from the power supply to the at least one heating element if the determined emission half-life corresponds to an aerosol-generating article configured for use with the aerosol-generating device.

The controller may be configured to determine the time taken for the intensity of photoluminescence to decrease by a predetermined amount during the second time period. The controller may be configured to control further operation of the aerosol-generating device based on the determined time.

The controller may be configured to compare the determined time with a look-up table of times corresponding to taggants of aerosol-generating articles configured for use with the aerosol-generating device. The controller may be configured so that the controlling further operation of the aerosol-generating device based on the determined time comprises preventing a supply of power from the power supply to the at least one heating element unless the determined time corresponds to an aerosol-generating article configured for use with the aerosol-generating device. The controller may be configured to supply power from the power supply to the at least one heating element if the determined time corresponds to an aerosol-generating article configured for use with the aerosol-generating device.

According to another example of the present disclosure, there is provided an aerosol-generating device. The aerosol-generating device may comprise a cavity for receiving at least a portion of an aerosol-generating article comprising a taggant. The aerosol-generating device may comprise a source of radiation arranged to irradiate a taggant of an aerosol-generating article when the aerosol-generating article is received within the cavity. The aerosol-generating device may comprise a photodetector arranged to detect radiation emitted by a taggant of an aerosol-generating article when the aerosol-generating article is received within the cavity.

According to another example of the present disclosure, there is provided an aerosol-generating device. The aerosol-generating device comprises a cavity for receiving at least a portion of an aerosol-generating article comprising a taggant. The aerosol-generating device also comprises a source of radiation arranged to irradiate a taggant of an aerosol-generating article when the aerosol-generating article is received within the cavity. The aerosol-generating device also comprises a photodetector arranged to detect radiation emitted by a taggant of an aerosol-generating article when the aerosol-generating article is received within the cavity.

The source of radiation may comprise a light emitting diode. Preferably, the light emitting diode is configured to emit radiation having at least one wavelength at which the photoluminescent material may be excited. The light emitting diode may be configured to emit infrared radiation. The light emitting diode may be configured to emit infrared radiation within a wavelength range of between about 700 nanometres and about 1100 nanometres.

The photodetector may comprise a photodiode.

The aerosol-generating device may comprise a power supply.

The aerosol-generating device may comprise at least one heating element.

The aerosol-generating device may comprise a controller configured to supply power from the power supply to the light emitting diode for a first time period to irradiate a taggant with radiation from the light emitting diode when an aerosol-generating article is received within the cavity. The first time period may be between about 200 microseconds and about 1.5 milliseconds.

The controller may be configured to supply power from the power supply to the photodiode for a second time period after the first time period. The controller may be configured to prevent the supply of power from the power supply to the light emitting diode during the second time period. The controller may be configured to receive a signal from the photodiode during the second time period. The signal may be indicative of an intensity of photoluminescence by a taggant.

The second time period may be between about 200 microseconds and about 1.5 milliseconds.

The controller may be configured to determine an emission half-life of a photoluminescent material of a taggant based on the signal received from the photodiode during the second time period. The controller may be configured to control further operation of the aerosol-generating device based on the determined emission half-life.

The controller may be configured to compare the determined emission half-life with a look-up table of emission half-lives corresponding to taggants of aerosol-generating articles configured for use with the aerosol-generating device. The controller may be configured so that the controlling further operation of the aerosol-generating device based on the determined emission half-life comprises preventing a supply of power from the power supply to the at least one heating element unless the determined emission half-life corresponds to an aerosol-generating article configured for use with the aerosol-generating device. The controller may be configured to supply power from the power supply to the at least one heating element if the determined emission half-life corresponds to an aerosol-generating article configured for use with the aerosol-generating device.

The controller may be configured to determine the time taken for the intensity of photoluminescence to decrease by a predetermined amount during the second time period. The controller may be configured to control further operation of the aerosol-generating device based on the determined time.

The controller may be configured to compare the determined time with a look-up table of times corresponding to taggants of aerosol-generating articles configured for use with the aerosol-generating device. The controller may be configured so that the controlling further operation of the aerosol-generating device based on the determined time comprises preventing a supply of power from the power supply to the at least one heating element unless the determined time corresponds to an aerosol-generating article configured for use with the aerosol-generating device. The controller may be configured to supply power from the power supply to the at least one heating element if the determined time corresponds to an aerosol-generating article configured for use with the aerosol-generating device.

In any of the examples or embodiments of the present disclosure comprising an aerosol-generating device described herein, the aerosol-generating device may comprise any of the following optional or preferred features.

The power supply may be any suitable power supply, for example a DC voltage source. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate or a Lithium-Polymer battery.

The controller may comprise a microprocessor. The microprocessor may be a programmable microprocessor, a microcontroller, or an application specific integrated chip (ASIC) or other electronic circuitry capable of providing control. The controller may comprise further electronic components. For example, in some embodiments, the controller may comprise any of: sensors, switches, display elements. Power may be supplied to the heater assembly continuously following activation of the device or may be supplied intermittently, such as on a puff-by-puff basis. The power may be supplied to the heater assembly in the form of pulses of electrical current, for example, by means of pulse width modulation (PWM).

The at least one heating element may be a single heating element. The at least one heating element may comprise a plurality of heating elements.

The at least one element may comprise at least one inductor coil. The at least one inductor coil may be wound around at least a portion of the cavity. The at least one inductor coil may be arranged to inductively heat one or more susceptor elements during use of the aerosol-generating device. The one or more susceptor elements may form part of the aerosol-generating article. The one or more susceptor elements may form part of the aerosol-generating device.

The aerosol-generating device may comprise a tubular susceptor element defining at least a portion of the cavity. During use, at least a portion of an aerosol-generating article inserted into the cavity may be received within the tubular susceptor element. Preferably, the at least one inductor coil extends around an external surface of the tubular susceptor element.

The aerosol-generating device may comprise one or more susceptor elements extending into the cavity and arranged to be received within a portion of an aerosol-generating article when the aerosol-generating article is inserted into the cavity.

The at least one element may be an electrically resistive heating element.

The electrically resistive heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal™, Kanthal™ and other iron-chromium-aluminium alloys, and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The electrically resistive heating element may be formed using a metal or metal alloy having a defined relationship between temperature and resistivity. Heating elements formed in this manner may be used to both heat and monitor the temperature of the heating element during operation.

The electrically resistive heating element may be deposited in or on a rigid carrier material or substrate. The electrically resistive heating element may be deposited in or on a flexible carrier material or substrate. The electrically resistive heating element may be formed as a track on a suitable insulating material, such as ceramic or glass or polyimide film. The electrically resistive heating element may be sandwiched between two insulating materials.

The electrically resistive heating element may comprise a heat-resistant flexible polyimide film having electrically resistive heating tracks formed on the film. The electrically resistive heating tracks may be formed in a serpentine pattern on the film. The electrically resistive heating tracks may comprise any of the suitable electrically resistive materials described herein.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating article comprising:
an aerosol-forming substrate; and
a taggant comprising a photoluminescent material having an emission half-life of between 50 microseconds and 1000 microseconds after photoexcitation of the photoluminescent material.

Example Ex2: An aerosol-generating article according to Example Ex1, wherein the photoluminescent material has an emission half-life of between 100 microseconds and 800 microseconds.

Example Ex3: An aerosol-generating article according to Example Ex1 or Ex2, wherein the photoluminescent material has an emission half-life of between 100 microseconds and 500 microseconds.

Example Ex4: An aerosol-generating article according to Example Ex1, Ex2 or Ex3, wherein the photoluminescent material has an emission half-life of between 100 microseconds and 300 microseconds.

Example Ex5: An aerosol-generating article according to any preceding Example, wherein the photoluminescent material has an emission half-life of between 120 microseconds and 250 microseconds.

Example Ex6: An aerosol-generating article according to any preceding Example, wherein the photoluminescent material has an emission half-life of between 160 microseconds and 200 microseconds.

Example Ex7: An aerosol-generating article according to any preceding Example, wherein the photoluminescent material is excitable by infrared radiation within a wavelength range of between 700 nanometres and 1050 nanometres.

Example Ex8: An aerosol-generating article according to any preceding Example, wherein the photoluminescent material exhibits photoluminescence within a wavelength range of between 700 nanometres and 1100 nanometres.

Example Ex9: An aerosol-generating article according to any preceding Example, wherein the photoluminescent material exhibits photoluminescence within a wavelength range of between 950 nanometres and 1050 nanometres.

Example Ex10: An aerosol-generating article according to any preceding Example, wherein the taggant is provided on an outer surface of the aerosol-generating article.

Example Ex11: An aerosol-generating article according to Example Ex10, wherein the taggant is provided as a continuous band circumscribing a portion of the outer surface.

Example Ex12: An aerosol-generating article according to any preceding Example, further comprising a wrapper, wherein the taggant is provided on a surface of the wrapper.

Example Ex13: An aerosol-generating article according to Example Ex12, wherein the taggant is provided on an inner surface of the wrapper.

Example Ex14: An aerosol-generating article according to any preceding Example, wherein the aerosol-forming substrate is provided as a segment of aerosol-forming substrate, and wherein the aerosol-generating article further comprises at least one further segment positioned downstream of the segment of aerosol-forming substrate.

Example Ex15: An aerosol-generating article according to Example Ex14, wherein the at least one further segment comprises:
at least one hollow tube positioned downstream of the segment of aerosol-forming substrate; and
at least one filter segment positioned downstream of the at least one hollow tube.

Example Ex16: An aerosol-generating article according to any preceding Example, wherein the aerosol-forming substrate comprises tobacco.

Example Ex17: An aerosol-generating article according to any preceding Example, wherein the aerosol-generating article comprises at least one susceptor element in thermal contact with the segment of aerosol-forming substrate.

Example Ex18: An aerosol-generating system comprising:
an aerosol-generating article according to any preceding Example; and
an aerosol-generating device, the aerosol-generating device comprising:
a cavity for receiving at least a portion of the aerosol-generating article;
a source of radiation arranged to irradiate the taggant when the aerosol-generating article is received within the cavity; and
a photodetector arranged to detect radiation emitted by the photoluminescent material when the aerosol-generating article is received within the cavity.

Example Ex19: An aerosol-generating system according to Example Ex18, wherein the source of radiation comprises a light emitting diode.

Example Ex20: An aerosol-generating system according to Example Ex19, wherein the light emitting diode is configured to emit infrared radiation within a wavelength range of between 700 nanometres and 1100 nanometres.

Example Ex21: An aerosol-generating system according to Example Ex18, Ex19 or Ex20, wherein the photodetector comprises a photodiode.

Example Ex22: An aerosol-generating system according to Example Ex19 or Ex20, wherein the aerosol-generating device further comprises:
a power supply; and
a controller configured to supply power from the power supply to the light emitting diode for a first time period to irradiate the taggant with radiation from the light emitting diode when the aerosol-generating article is received within the cavity.

Example Ex23: An aerosol-generating system according to Example Ex22, wherein the first time period is between 200 microseconds and 1.5 milliseconds.

Example Ex24: An aerosol-generating system according to Example Ex21 in combination with Example Ex22 or Example Ex23, wherein the controller is further configured to: supply power from the power supply to the photodiode for a second time period after the first time period;
prevent the supply of power from the power supply to the light emitting diode during the second time period;
receive a signal from the photodiode during the second time period;
determine an emission half-life of the photoluminescent material of the taggant based on the signal received from the photodiode during the second time period; and
control further operation of the aerosol-generating device based on the determined emission half-life.

Example Ex25: An aerosol-generating system according to Example Ex24, wherein the second time period is between 200 microseconds and 1.5 milliseconds.

Example Ex26: An aerosol-generating system according to Example Ex21 in combination with Example Ex22 or Example Ex23, wherein the controller is further configured to:
supply power from the power supply to the photodiode for a second time period after the first time period;
prevent the supply of power from the power supply to the light emitting diode during the second time period;
receive a signal from the photodiode during the second time period, wherein the signal is indicative of an intensity of photoluminescence by the taggant;
determine the time taken for the intensity of photoluminescence to decrease by a predetermined amount during the second time period; and
control further operation of the aerosol-generating device based on the determined time.

Example Ex27: An aerosol-generating system according to any of Examples Ex18 to Ex25, wherein the aerosol-generating device further comprises at least one heating element.

Example Ex28: An aerosol-generating system according to Example Ex27 in combination with Example Ex24 or Example Ex25, wherein the controller is configured to compare the determined emission half-life with a look-up table of emission half-lives corresponding to taggants of aerosol-generating articles configured for use with the aerosol-generating device, and wherein the controlling further operation of the aerosol-generating device based on the determined emission half-life comprises:
preventing a supply of power from the power supply to the at least one heating element unless the determined emission half-life corresponds to an aerosol-generating article configured for use with the aerosol-generating device; and
supplying power from the power supply to the at least one heating element if the determined emission half-life corresponds to an aerosol-generating article configured for use with the aerosol-generating device.

Example Ex29: An aerosol-generating system according to Example Ex26 in combination with Example Ex27, wherein the controller is configured to compare the determined time with a look-up table of times corresponding to taggants of aerosol-generating articles configured for use with the aerosol-generating device, and wherein the controlling further operation of the aerosol-generating device based on the determined time comprises:
preventing a supply of power from the power supply to the at least one heating element unless the determined time corresponds to an aerosol-generating article configured for use with the aerosol-generating device; and
supplying power from the power supply to the at least one heating element if the determined time corresponds to an aerosol-generating article configured for use with the aerosol-generating device.

Example Ex30: An aerosol-generating system according to Example Ex27, Ex28 or Ex29, wherein the at least one heating element comprises an inductor coil.

Example Ex31: An aerosol-generating device comprising:
a cavity for receiving at least a portion of an aerosol-generating article comprising a taggant;
a source of radiation arranged to irradiate a taggant of an aerosol-generating article when the aerosol-generating article is received within the cavity; and
a photodetector arranged to detect radiation emitted by a taggant of an aerosol-generating article when the aerosol-generating article is received within the cavity.

Example Ex32: An aerosol-generating device according to Example Ex31, wherein the source of radiation comprises a light emitting diode.

Example Ex33: An aerosol-generating device according to Example Ex32, wherein the light emitting diode is configured to emit infrared radiation within a wavelength range of between 700 nanometres and 1100 nanometres.

Example Ex34: An aerosol-generating device according to Example Ex31, Ex32 or Ex33, wherein the photodetector comprises a photodiode.

Example Ex35: An aerosol-generating device according to Example Ex32 or Ex33, further comprising:
a power supply; and
a controller configured to supply power from the power supply to the light emitting diode for a first time period to irradiate a taggant with radiation from the light emitting diode when an aerosol-generating article is received within the cavity.

Example Ex36: An aerosol-generating device according to Example Ex35, wherein the first time period is between 200 microseconds and 1.5 milliseconds.

Example Ex37: An aerosol-generating device according to Example Ex34 in combination with Example Ex35 or Example Ex36, wherein the controller is further configured to: supply power from the power supply to the photodiode for a second time period after the first time period;
prevent the supply of power from the power supply to the light emitting diode during the second time period;
receive a signal from the photodiode during the second time period;
determine an emission half-life of a photoluminescent material of a taggant based on the signal received from the photodiode during the second time period; and
control further operation of the aerosol-generating device based on the determined emission half-life.

Example Ex38: An aerosol-generating device according to Example Ex37, wherein the second time period is between 200 microseconds and 1.5 milliseconds.

Example Ex39: An aerosol-generating device according to Example Ex34 in combination with Example Ex35 or Example Ex36, wherein the controller is further configured to:
supply power from the power supply to the photodiode for a second time period after the first time period;
prevent the supply of power from the power supply to the light emitting diode during the second time period;
receive a signal from the photodiode during the second time period, wherein the signal is indicative of an intensity of photoluminescence by a taggant;
determine the time taken for the intensity of photoluminescence to decrease by a predetermined amount during the second time period; and
control further operation of the aerosol-generating device based on the determined time.

Example Ex40: An aerosol-generating device according to any of Examples Ex31 to Ex38, further comprising at least one heating element.

Example Ex41: An aerosol-generating device according to Example Ex40 in combination with Example Ex37 or Example Ex38, wherein the controller is configured to compare the determined emission half-life with a look-up table of emission half-lives corresponding to taggants of aerosol-generating articles configured for use with the aerosol-generating device, and wherein the controlling further operation of the aerosol-generating device based on the determined emission half-life comprises:
preventing a supply of power from the power supply to the at least one heating element unless the determined emission half-life corresponds to an aerosol-generating article configured for use with the aerosol-generating device; and
supplying power from the power supply to the at least one heating element if the determined emission half-life corresponds to an aerosol-generating article configured for use with the aerosol-generating device.

Example Ex42: An aerosol-generating device according to Example Ex39 in combination with Example Ex40, wherein the controller is configured to compare the determined time with a look-up table of times corresponding to taggants of aerosol-generating articles configured for use with the aerosol-generating device, and wherein the controlling further operation of the aerosol-generating device based on the determined time comprises:
preventing a supply of power from the power supply to the at least one heating element unless the determined time corresponds to an aerosol-generating article configured for use with the aerosol-generating device; and
supplying power from the power supply to the at least one heating element if the determined time corresponds to an aerosol-generating article configured for use with the aerosol-generating device.

Example Ex43: An aerosol-generating device according to Example Ex40, Ex41 or Ex42, wherein the at least one heating element comprises an inductor coil.

The invention will be further described, by way of example only, with reference to the accompanying drawings in which:

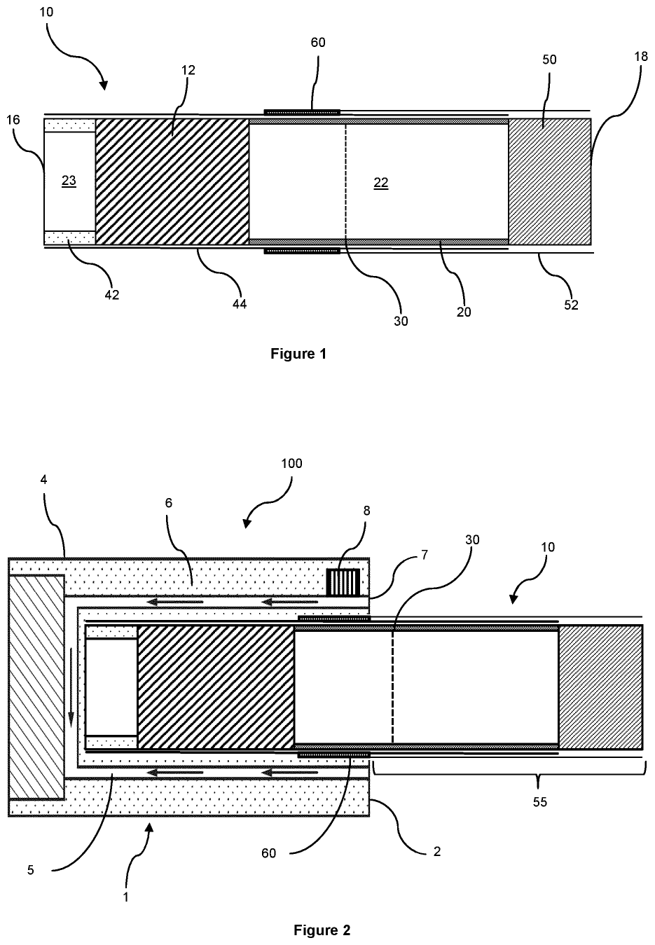

FIG. 1 shows a schematic side cross-sectional view of an aerosol-generating article in accordance with an embodiment of the present disclosure; and

FIG. 2 shows a schematic side cross-sectional view of the aerosol-generating system comprising the aerosol-generating article of FIG. 1 and an aerosol-generating device.

The aerosol-generating article 10 shown in FIG. 1 comprises a segment of aerosol-forming substrate 12 and a downstream section at a location downstream of the aerosol-forming substrate 12. The aerosol-generating article 10 extends from an upstream or distal end 16 to a downstream or mouth end 18. The downstream section comprises a hollow tubular element 20 and a mouthpiece element 50.

The aerosol-generating article 10 has an overall length of about 45 millimetres and an outer diameter of about 7.2 millimetres.

The aerosol-forming substrate 12 comprises a shredded tobacco material. The aerosol-forming substrate 12 comprises 150 milligrams of a shredded tobacco material comprising from 13 percent by weight to 16 percent by weight of glycerine. The density of the aerosol-forming substrate is about 300 milligrams per cubic centimetre. The RTD of the aerosol-forming substrate 12 is between about 6 millimetres of water to about 8 millimetres of water. The aerosol-forming substrate 12 is individually wrapped by a plug wrap (not shown).

The hollow tubular element 20 is located immediately downstream of the aerosol-forming substrate 12, the hollow tubular element 20 being in longitudinal alignment with the aerosol-forming substrate 12. The upstream end of the hollow tubular element 20 abuts the downstream end of the aerosol-forming substrate 12.

The hollow tubular element 20 defines a hollow section of the aerosol-generating article 10. The hollow tubular element does not substantially contribute to the overall RTD of the aerosol-generating article. In more detail, an RTD of the hollow tubular element 20 is about 0 millimetres of water.

The hollow tubular element 20 is provided in the form of a hollow cylindrical tube made of cardboard. The hollow tubular element 20 defines an internal cavity 22 that extends all the way from an upstream end of the hollow tubular element 20 to a downstream end of the hollow tubular element 20. The internal cavity 22 is substantially empty, and so substantially unrestricted airflow is enabled along the internal cavity 22. The hollow tubular element 20 does not substantially contribute to the overall RTD of the aerosol-generating article 10.

The hollow tubular element 20 has a length of about 21 millimetres, an external diameter of about 7.2 millimetres, and an internal diameter of about 6.7 millimetres. A thickness of a peripheral wall of the hollow tubular element 20 is about 0.25 millimetres.

The aerosol-generating article 10 comprises a ventilation zone 30 provided at a location along the hollow tubular element 20. In more detail, the ventilation zone 30 is provided at about 16 millimetres from the downstream end 18 of the article 10. The ventilation zone 30 is provided at about 12 millimetres downstream from the downstream end of the aerosol-forming substrate 12. The ventilation zone 30 is provided at about 9 millimetres upstream from the upstream end of the mouthpiece element 50. The ventilation zone 30 comprises a circumferential row of openings or perforations circumscribing the hollow tubular element 20. The perforations of the ventilation zone 30 extend through the wall of the hollow tubular element 20, in order to allow fluid ingress into the internal cavity 22 from the exterior of the article 10. A ventilation level of the aerosol-generating article 10 is about 16 percent.

In addition to the aerosol-forming substrate 12 and the downstream section at a location downstream of the aerosol-forming substrate 12, the aerosol-generating article 10 comprises an upstream section at a location upstream of the aerosol-forming substrate 12. As such, the aerosol-generating article 10 extends from a distal end 16 substantially coinciding with an upstream end of the upstream section to a mouth end or downstream end 18 substantially coinciding with a downstream end of the downstream section.

The upstream section comprises an upstream element 42 located immediately upstream of the aerosol-forming substrate 12, the upstream element 42 being in longitudinal alignment with the aerosol-forming substrate 12. The downstream end of the upstream element 42 abuts the upstream end of the aerosol-forming substrate 12. The upstream element 42 is provided in the form of a hollow cylindrical plug of cellulose acetate tow having a wall thickness of about 1 millimetre and defining an internal cavity 23. The upstream element 42 has a length of about 5 millimetres. An external diameter of the upstream element 42 is about 7.1 millimetres. An internal diameter of the upstream element 42 is about 5.1 millimetres.

The mouthpiece element 50 extends from the downstream end of the hollow tubular element 20 to the downstream or mouth end of the aerosol-generating article 10. The mouthpiece element 50 has a length of about 7 millimetres. An external diameter of the mouthpiece element 50 is about 7.2 millimetres. The mouthpiece element 50 comprises a low-density, cellulose acetate filter segment. The RTD of the mouthpiece element 50 is about 8 millimetres of water. The mouthpiece element 50 may be individually wrapped by a plug wrap (not shown).

As shown in FIG. 1, the article 10 comprises an upstream wrapper 44 circumscribing the upstream element 42, the aerosol-forming substrate 12 and the hollow tubular element 20. The ventilation zone 30 may also comprise a circumferential row of perforations provided on the upstream wrapper 44. The perforations of the upstream wrapper 44 overlap the perforations provided on the hollow tubular element 20. Accordingly, the upstream wrapper 44 overlies the perforations of the ventilation zone 30 provided on the hollow tubular element 20.

The article 10 also comprises a tipping wrapper 52 circumscribing the hollow tubular element 20 and the mouthpiece element 50. The tipping wrapper 52 overlies the portion of the upstream wrapper 44 that overlies the hollow tubular element 20. Therefore, the tipping wrapper 52 secures the mouthpiece element 50 to the rest of the components of the article 10. The width of the tipper wrapper 52 is about 26 millimetres. Additionally, the ventilation zone 30 may comprise a circumferential row of perforations provided on the tipping wrapper 52. The perforations of the tipping wrapper 52 overlap the perforations provided on the hollow tubular element 20 and the upstream wrapper 44. Accordingly, the tipping wrapper 52 overlies the perforations of the ventilation zone 30 provided on the hollow tubular element 20 and the upstream wrapper 44.

A taggant 60 is provided as a continuous band circumscribing a portion of the downstream section of the aerosol-generating article 10. The taggant 60 is printed on the inner surface of the tipping wrapper 52. The upstream end of the taggant 60 is located 2 millimetres downstream of the downstream end of the aerosol-forming substrate 12. The taggant 60 has a length of 6.5 millimetres. The upstream end of the taggant 60 is aligned with the upstream end of the tipping wrapper 52. The downstream end of the taggant 60 is 3.5 millimetres upstream from the ventilation zone 30. Accordingly, the entire length of the taggant 60 overlays a portion of the hollow tubular element 20. The taggant 60 is provided in a concentration of about 200 milligrams per square metre.

The taggant 60 comprises a photoluminescent material having an emission half-life of between about 50 microseconds and about 1000 microseconds. The photoluminescent material is excitable by infrared radiation within a wavelength range of between about 700 nanometres and about 1050 nanometres. The photoluminescent material exhibits photoluminescence within a wavelength range of between about 700 nanometres and about 1100 nanometres.

FIG. 2 illustrates an aerosol-generating system 100 comprising an aerosol-generating device 1 and the aerosol-generating article 10 of FIG. 1. FIG. 2 illustrates a downstream, mouth end portion of the aerosol-generating device 1 comprising a cavity in which the aerosol-generating article 10 is received. The aerosol-generating device 1 comprises a housing (or body) 4 extending between a mouth end 2 and a distal end (not shown). The housing 4 comprises a peripheral wall 6. The peripheral wall 6 defines the cavity for receiving the aerosol-generating article 10. The device cavity is defined by a closed, distal end and an open, mouth end. The mouth end of the device cavity is located at the mouth end of the aerosol-generating device 1. The aerosol-generating article 10 is configured to be received through the mouth end of the device cavity and is configured to abut a closed end of the device cavity.

A device air flow channel 5 is defined within the peripheral wall 6. The air flow channel 5 extends between an inlet 7 located at the mouth end of the aerosol-generating device 1 and the closed end of the device cavity. Air may enter the aerosol-forming substrate 12 via an aperture (not shown) provided at the closed end of the device cavity, ensuring fluid communication between the air flow channel 5 and the aerosol-forming substrate 12.

The aerosol-generating device 1 further comprises a heating element (not shown) and a power supply (not shown) for supplying power to the heating element. A controller (not shown) is also provided to control a supply of power to the heating element. The heating element is configured to controllably heat the aerosol-generating article 10 during use, when the aerosol-generating article 10 is received within the device 1. The heating element is preferably arranged to externally heat the aerosol-forming substrate 12 for optimal aerosol generation. The ventilation zone 30 is arranged to be exposed when the aerosol-generating article 10 is received within the aerosol-generating device 1.

In the embodiment shown in FIG. 2, the device cavity defined by the peripheral wall 6 is 28 millimetres in length. When the article 10 is received within the cavity, the upstream section, the aerosol-forming substrate 12 and an upstream portion of the hollow tubular element 20 are received within the device cavity. Such an upstream portion of the hollow tubular element 20 is 11 millimetres in length. Accordingly, about 28 millimetres of the article 10 is received within the device 1 and about 17 millimetres of the article 10 is located outside of the device 1. In other words, about 17 millimetres of the article 10 protrudes from the device 1 when the article 10 is received therein. Such a length 55 of the article 10 protruding from the device 1 is shown in FIG. 2.

As a result, the ventilation zone 30 is advantageously located outside of the device 1 when the article 10 is inserted in the device 1. Where the device cavity is 28 millimetres long, the ventilation zone 30 is located 1 millimetres downstream from the mouth end 2 of the device 1 when the article 10 is received within the device 1.

The aerosol-generating device 1 further comprises a taggant detector 8 located near the device cavity. The taggant detector 8 is located about 2 millimetres from the downstream end, or mouth end, of the device cavity. The taggant detector 8 may be configured to detect the presence, absence, and type of taggant 60 located on an aerosol-generating article 10. The taggant detector 8 comprises a light emitting diode configured to infrared radiation within a wavelength range of between 700 nanometres and 1100 nanometres. The light emitting diode is arranged to irradiate the taggant 60 when the aerosol-generating article 10 is received within the cavity. The taggant detector 8 also comprises a photodetector arranged to detect infrared radiation emitted by the photoluminescent material of the taggant 60 when the aerosol-generating article 10 is received within the cavity. The controller is configured to supply power from the power supply to the light emitting diode. The controller is configured to receive signals from the photodetector.

In use, the aerosol-generating article 10 is inserted into the device cavity of the aerosol-generating device 1. When the aerosol-generating article 10 is fully inserted into the device cavity, the taggant 60 of the aerosol-generating article 10 is aligned with the taggant detector 8 of the aerosol-generating device 1. The light emitting diode of the taggant detector 8 irradiates the taggant 60 with infrared radiation. The photodetector of the taggant detector 8 then detects infrared radiation emitted by the taggant 60 and provides signals to the controller indicative of an intensity of the emitted infrared radiation. Based on the signals from the photodetector, the controller then determines an emission half-life of the taggant 60, or the time taken for the intensity of the emitted infrared radiation to decrease by a predetermined amount.

Based on the determined emission half-life or time taken for the intensity of the emitted infrared radiation to decrease by a predetermined amount, the controller determines by comparison with a lookup table whether the aerosol-generating article 10 is an article designed for use with the aerosol-generating device 1.

If the aerosol-generating article 10 is an article designed for use with the aerosol-generating device 1, the controller supplies power from the power supply to the heating element according to a predetermined heating profile to generate an aerosol from the aerosol-forming substrate 12. The taggant 60 remains distant from the area which is heated thereby preventing the taggant 60 from being damaged. Similarly, the taggant detector 8 also remains distant from the area which is heated thereby preventing build-up of heating by-products and slurry on the taggant detector 8.

If the aerosol-generating article 10 is not recognised as an article designed for use with the aerosol-generating device 1, the controller prevents the supply of power from the power supply to the heating element.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristics of the claimed invention. Also, all ranges include the maximum and minimum points disclosed and include any intermediate ranges therein, which may or may not be specifically enumerated herein.

1.-43. (canceled)

44. An aerosol-generating article, comprising:
an aerosol-forming substrate; and
a taggant comprising a photoluminescent material having an emission half-life of between 50 microseconds and 1000 microseconds after photoexcitation of the photoluminescent material.

45. The aerosol-generating article according to claim 44, wherein the photoluminescent material is excitable by infrared radiation within a wavelength range of between 700 nanometres and 1050 nanometres.

46. The aerosol-generating article according to claim 44, wherein the photoluminescent material exhibits photoluminescence within a wavelength range of between 700 nanometres and 1100 nanometres.

47. The aerosol-generating article according to claim 44, wherein the taggant is provided as a continuous band circumscribing a portion of an outer surface of the aerosol-generating article.

48. The aerosol-generating article according to claim 44,
further comprising a wrapper,
wherein the taggant is provided on an inner surface of the wrapper.

49. The aerosol-generating article according to claim 44,
wherein the aerosol-forming substrate is provided as a segment of aerosol-forming substrate,
wherein the aerosol-generating article further comprises at least one further segment positioned downstream of the segment of aerosol-forming substrate, and
wherein the at least one further segment comprises:
at least one hollow tube positioned downstream of the segment of aerosol-forming substrate, and
at least one filter segment positioned downstream of the at least one hollow tube.

50. An aerosol-generating system, comprising:
the aerosol-generating article according to claim 44; and
an aerosol-generating device comprising:
a cavity configured to receive at least a portion of the aerosol-generating article,
a source of radiation arranged to irradiate the taggant when the aerosol-generating article is received within the cavity, and
a photodetector arranged to detect radiation emitted by the photoluminescent material when the aerosol-generating article is received within the cavity.

51. The aerosol-generating system according to claim 50, wherein the source of radiation comprises a light emitting diode.

52. The aerosol-generating system according to claim 51, wherein the light emitting diode is configured to emit infrared radiation within a wavelength range of between 700 nanometres and 1100 nanometres.

53. The aerosol-generating system according to claim 51, wherein the photodetector comprises a photodiode.

54. The aerosol-generating system according to claim 53, wherein the aerosol-generating device further comprises:
a power supply, and
a controller configured to supply power from the power supply to the light emitting diode for a first time period to irradiate the taggant with radiation from the light emitting diode when the aerosol-generating article is received within the cavity.

55. The aerosol-generating system according to claim 54, wherein the first time period is between 200 microseconds and 1.5 milliseconds.

56. The aerosol-generating system according to claim 54, wherein the controller is further configured to:
supply power from the power supply to the photodiode for a second time period after the first time period,
prevent the supply of power from the power supply to the light emitting diode during the second time period,
receive a signal from the photodiode during the second time period,
determine an emission half-life of the photoluminescent material of the taggant based on the signal received from the photodiode during the second time period, and
control further operation of the aerosol-generating device based on the determined emission half-life.

57. The aerosol-generating system according to claim 56, wherein the second time period is between 200 microseconds and 1.5 milliseconds.

58. The aerosol-generating system according to claim 56,
wherein the aerosol-generating device further comprises at least one heating element,
wherein the controller is further configured to compare the determined emission half-life with a look-up table of emission half-lives corresponding to taggants of aerosol-generating articles configured for use with the aerosol-generating device, and
wherein the controlling further operation of the aerosol-generating device based on the determined emission half-life comprises:
preventing a supply of power from the power supply to the at least one heating element unless the determined emission half-life corresponds to an aerosol-generating article configured for use with the aerosol-generating device, and
supplying power from the power supply to the at least one heating element if the determined emission half-life corresponds to an aerosol-generating article configured for use with the aerosol-generating device.

59. The aerosol-generating system according to claim 54, wherein the controller is further configured to:
supply power from the power supply to the photodiode for a second time period after the first time period,
prevent the supply of power from the power supply to the light emitting diode during the second time period,
receive a signal from the photodiode during the second time period, wherein the signal is indicative of an intensity of photoluminescence by the taggant,
determine the time taken for the intensity of photoluminescence to decrease by a predetermined amount during the second time period, and
control further operation of the aerosol-generating device based on the determined time.

60. The aerosol-generating system according to claim 59,
wherein the aerosol-generating device further comprises at least one heating element,
wherein the controller is configured to compare the determined time with a look-up table of times corresponding to taggants of aerosol-generating articles configured for use with the aerosol-generating device, and
wherein the controlling further operation of the aerosol-generating device based on the determined time comprises:
preventing a supply of power from the power supply to the at least one heating element unless the determined time corresponds to an aerosol-generating article configured for use with the aerosol-generating device, and
supplying power from the power supply to the at least one heating element if the determined time corresponds to an aerosol-generating article configured for use with the aerosol-generating device.

61. An aerosol-generating device, comprising:
a cavity configured to receive at least a portion of an aerosol-generating article comprising a taggant;
a source of radiation arranged to irradiate the taggant of the aerosol-generating article when the aerosol-generating article is received within the cavity, wherein the source of radiation comprises a light emitting diode;
a photodetector arranged to detect radiation emitted by the taggant of the aerosol-generating article when the aerosol-generating article is received within the cavity, wherein the photodetector comprises a photodiode;
a power supply; and
a controller configured to supply power from the power supply to the light emitting diode for a first time period to irradiate the taggant with radiation from the light emitting diode when the aerosol-generating article is received within the cavity,
wherein the controller is further configured to:
supply power from the power supply to the photodiode for a second time period after the first time period,
prevent the supply of power from the power supply to the light emitting diode during the second time period,
receive a signal from the photodiode during the second time period,
determine an emission half-life of a photoluminescent material of a taggant based on the signal received from the photodiode during the second time period, and
control further operation of the aerosol-generating device based on the determined emission half-life.

62. The aerosol-generating device according to claim 61, wherein the light emitting diode is configured to emit infrared radiation within a wavelength range of between 700 nanometres and 1100 nanometres.

63. The aerosol-generating device according to claim 61,
further comprising at least one heating element,
wherein the controller is further configured to compare the determined emission half-life with a look-up table of emission half-lives corresponding to taggants of aerosol-generating articles configured for use with the aerosol-generating device, and
wherein the controlling further operation of the aerosol-generating device based on the determined emission half-life comprises:
preventing a supply of power from the power supply to the at least one heating element unless the determined emission half-life corresponds to an aerosol-generating article configured for use with the aerosol-generating device, and
supplying power from the power supply to the at least one heating element if the determined emission half-life corresponds to the aerosol-generating article configured for use with the aerosol-generating device.
